(19) United States
(12) Patent Application Publication
(10) Pub. No.: US 2006/0138380 A1
(43) Pub. Date: Jun. 29, 2006

(54) Aqueous liquid compositions of cyclodextrine or cyclodextrine derivatives and a process using the said composition

(76) Inventors: Torsten Kulke, East Yorkshire (GB); Walter Nassl, Muhlhausen (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/562,366

(22) PCT Filed: Jun. 18, 2004
(86) PCT No.: PCT/EP04/51162

§ 371 Date: Dec. 22, 2005

(30) Foreign Application Priority Data
Jun. 26, 2003 (EP) 034054676

(51) Int. Cl. D06M 15/333; C08B 5/10

(52) U.S. Cl. 252/8.83; 536/41

(57) ABSTRACT

An aqueous liquid composition comprising a cyclodextrin or a cyclodextrine derivative, at least one emulsifier and a resin finishing or crosslinking agent is excellent in storage stability and useful in a finishing process for the treatment of suitable substrates, such as fibre materials.

The present invention relates to an aqueous liquid composition of excellent stability in finishing applications comprising cyclodextrin or a derivative thereof, a resin finishing agent or a crosslinking agent and at least one emulsifier, and a process for the treatment of suitable substrates, in particular fibre materials, using the said composition.

Industrial finishing processes are usually carried out in an aqueous medium. When used for the finishing process finishing agents commercially available in the form of powder or granule must be dissolved in an aqueous medium using water.

In recent years, such finishing processes have been mechanized and automated in many aspects, and therefore the finishing agents have been eagerly required to be made into a form suitable for a dispensing system.

Cyclodextrins are cage like molecules of a cyclic configuration made up of a varying number of D-glucopyranosyl units, such as 6, 7 or 8 units (α-, β- or γ-cyclodextrins), connected by alpha-(1,4) glycosidic linkages, thereby defining a central cavity. The chemical formula of α-cyclodextrin is depicted below.

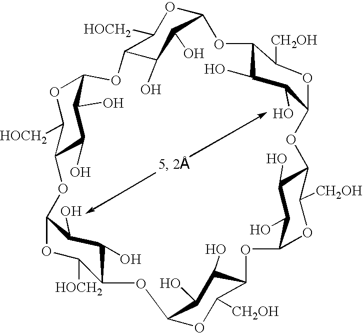

The natural cyclodextrins are produced from starch by the action of cyclodextrin glycosyltransferase (CGTase), an enzyme produced by several organisms, Bacillus macerans being the earliest source. The most stable three-dimensional molecular configuration for these cyclic oligosaccharides takes the form of a toroid with the upper (larger) and lower (smaller) opening of the toroid presenting secondary and primary hydroxyl groups, respectively, to the solvent environment. The interior of the toroid is hydrophobic as a result of the electron rich environment provided in large part by the glycosidic oxygen atoms. It is the interplay of atomic (Van der Waals), thermodynamic (hydrogen bonding), and solvent (hydrophobic) forces that accounts for stable complexes that may be formed with chemical substances while in the apolar environment of the cyclodextrin cavity. The complex exists in an equilibrium dependent upon the concentrations of the cyclodextrin, the guest molecule and water. The rate at which the associated complex is formed is determined in large part by the accessibility of the guest molecule to the cyclodextrin cavity and the magnitude of the net thermodynamic driving force.

Uncomplexed cyclodextrin derivatives have been used as finishing agents for the treatment of fibre materials in order to reduce or prevent malodors due to perspiration (DE-A40 35 378). Moreover, uncomplexed cyclodextrin derivatives allow for the complexation of fragrances and perfumes (DE-A-40 35 378) or antimicrobial substances (WO-A-02/22941), which are released slowly and impart long-lasting fragrance or a prolonged antimicrobial effect to the finished textile material. The prolonged presence of antimicrobials makes the substrates more hygienic, less prone to cross contamination and fresher.

An aqueous liquid composition of a cyclodextrine or a cyclodextrine derivative thereof is considered advantageous, since it is suitable for the automatic weighing and dispensing system and causes no powder-scattering during handling, resulting in no pollution of the working environment, and moreover it can serve saving energy and labor, since substituted cyclodextrin derivatives are prone to swelling upon contact with water and therefore have a strong tendency to form lumps which can hardly be dissolved.

Accordingly it is the subject of the present invention to provide a stable aqueous liquid composition comprising
a) a cyclodextrin or a derivative thereof,
b) a resin finishing or crosslinking agent, and
c) at least one emusifier of the formulae (1), (2), (3), (4), (5) or (6), 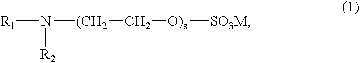
wherein R₁ and R₂ is alkyl or alkenyl having 12 bis 24 carbon atoms, M is hydrogen, alkali metal or ammonium und s is an integer from 2 to 14, 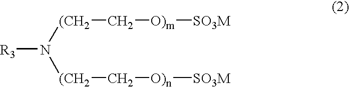
wherein R₃ is alkyl or alkenyl having 12 bis 24 carbon atoms, M is hydrogen, alkali metal or ammonium and m und n are integers such that the sum of m and n is 2 to 14, 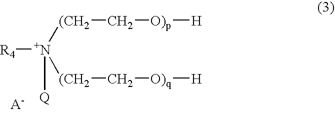
wherein R₄ is alkyl or alkenyl having 12 to 24 carbon atoms, Q is C₁-C₄ alkyl, A is an anion, especially CH₃—SO₄-Anion and p und q are integers such that the sum of p and q is 15 to 55, 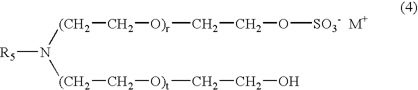
wherein R₅ is alkyl or alkenyl having 12 to 24 carbon atoms, r and t are integers such that the sum of r and t is 14 to 19 and M is an alklali metal or ammonium, 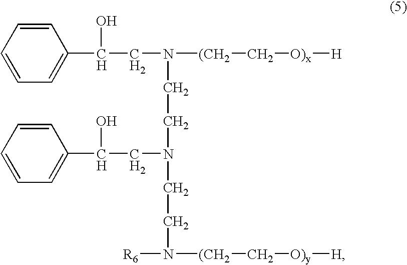
wherein R₆ is alkyl or alkenyl having 12 to 22 carbon atoms, x and y are integers such that the sum of x and y is 80 to 140, or
isotridecylalcohol containing 6 to 15 mols ethylene oxide of the formula 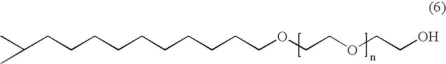
   wherein n is an integer from 6 to 15.

The emulsifier aids formulation flexibility when other finishing agents, such as softeners, oil- or water repellants, stain release agents, flame retardants or other effect finishing agents are applied together to the textile in one finishing step. The resin finishing or crosslinking agent aids to bind the cyclodextrine or its derivative to the material, especially to the textil fiber material. A thermal after treatment builds a polymeric film on the material, especially on the textile compound or it causes crosslinking of reactive groups within the material, especially within the textile fiber material at ambient or elevated temperatures The resin finishing or crosslinking agent is a compound able to reticulate to a polymeric film or to undergo chemical reactions with nucleophilic or electrophilic sites or chemical groups of said material. It is surprising and could not be foreseen that the present composition results in a stable finishing liquor.

The radical Q and the anion A⁻ in formula (3) are derived from quaternising agents. Q being a substituted or unsubstituted alkyl radical. Examples of suitable such quaternising agents are chloroacetamide, ethyl bromide, ethylenechlorohydrine, ethylenebromohydrine, epichlorohydrine, epibromohydrine, and, in particular, dimethyl sulfate.

Especially preferred emulsifiers or mixtures thereof are those of the fomula (3), (4) and (6).

The emulsifiers may be used in an amount, wherein the molar ratio of cyclodextrin or cyclo-dextrin derivative and emulsifier is 1:0.005 to 1:10, preferred is a molar ration of cyclo-dextrine or cyclodextrine derivative and emulsifier of 1:0.05 to 1:2, an especially preferred molar ratio of cyclodextrine or cyclodextrine derivative and emulsifier is 1:0.2 to 1:1.

The compounds of the formulae (1), (2), (3), (4), (5) and (6) are known and can be prepared according to known processes. Compounds of formula (1) and (2) can be prepared by addition of 2 to 14 mols ethylene oxide onto aliphatic amines which have an alkyl or alkenyl radical having 12 to 24 carbon atoms, and converting the adduct into the acid ester and the latter, if desired, into its alkali metal or ammonium salts. Compounds of formula (3) are prepared by addition of, for example, 15 to 55 mols of ethylene oxide onto aliphatic amines which have an alkyl or alkenyl radical havin 12 to 24 carbon atoms, and reacting the adduct with one of the above mentioned quaternising agents to give the compound of the formula (3). Compounds of the formula (4) are prepared in analogy to the compounds of the formula (1) using a smaller amount to convert the adduct into the acid ester and the latter, if desired, into its alkali metal or ammonium salts. Compounds of the formula (5) are prepared by the addition of 80 to 140 mols of ethylene oxide onto a compound of the formula 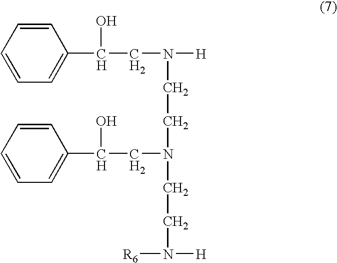
in which R₆ is as defined under formula (5).

Amines required as starting materials in the preparation of the compounds of the formulae (1), (2), (3) and (4) can have saturated or unsaturated, branched or unbranched hydrocarbon radicals having 12 to 24, preferably 16 to 22 carbon atoms. The amines can be single compounds or be in the form of mixtures. The amine mixture used are preferably those formed in the conversion of natural fats or oils, for example tallow fat or soya bean or coconut oil, into the corresponding amines. Specific examples of amines are dodecylamine, hexadecylamine, octadecylamine, arachidylamine, behenylamine, and octadecenylamine. Not only the addition of ethylene oxide but also the esterification can be carried out according to methods known per se. The esterification can be performed with sulfuric acid or its functional derivatives, for example chlorosulfonic acid or, in particular, sulfamic acid. The esterification is generally carried out by simply mixing the reactants while heating them, advantageously at a temperature between 50° and 100° C. The free acids can be converted into the alkali metal or ammonium salts by adding in a conventional manner bases, for example moonia or sodium or potassium hydroxide.

The cyclodextrin derivatives may be uncomplexed or complexed, for example, with antimicrobials, biocides, bactericides, insecticides, fungicides, pharmaceutical active compounds, UV-stabilizers, perfumes, fragrances, pheromones, vitamines or skin-, hair and textile benefit agents, e.g. UV-absorber, fatty acids, anti-irritants, inflammatory agents or cosmetic agents, e.g. skin firming, soothing, warming, cooling, wrinkle reducing or control agents.

The preparation of complexed reactive cyclodextrine derivatives can be carried out according to known processes, such as described in WO-A-02/22941.

As cyclodextrine derivatives it is suitable to use hydroxypropyl-β-cyclodextrine, other non reactive substituted β-cyclodextrine, or a cyclodextrine having a fibre reactive group.

Reactive groups of the cyclodextrin derivatives are groups capable of reacting with functional groups of a suitable substrate, such as a textile fibre material, for example with the hydroxyl groups of cellulose, the amino, carboxyl, hydroxyl or thiol groups in the case of wool and silk or with the amino and possibly carboxyl groups of synthetic polyamides with the formation of covalent chemical bonds. Reactive groups are generally attached directly or via a bridge member to a carbon atom of the cyclodextrin derivative. Examples of suitable reactive groups include those, which contain at least one detachable substituent on an aliphatic, aromatic or preferably on a heterocyclic radical or in which the radicals mentioned contain a radical suitable for reaction with the fibre material. Examples of suitable bridge members according to which the fibre-reactive groups can be attached to a carbon atom of the cyclo-dextrin derivative are —NH—, —O—CO— and —O—, especially —O—CO— and —O, and preferably —O—.

Reactive cyclodextrin derivatives are known and the preparation of such reactive cyclodextrin derivatives can be carried out according to known processes.

Reactive cyclodextrin derivatives containing aldehyde groups capable of reacting with the hydroxyl groups of cellulose or polyvinyl alcohol are described in EP-A-0 483 380.

A. Deratani, B. Pöpping, Makromol. Chem. Rapid Commun. 13 (1992) 237 describe the preparation of cyclodextrin chlorohydrin (3-chloro-2-hydroxypropyl-cyclodextrin derivative) by reaction of β-cyclodextrin in an aqueous medium with epichlorohydrin.

German patent application No. 101 55 782.5 furthermore discloses the preparation of β-cyclodextrin derivatives containing reactive 2,3-dibromopropionyl- or vinylsulfonyl groups which are well known reactive anchor groups in the field of reactive dyestuffs.

Basically, all fibre reactive groups known in the field of reactive dyestuffs, such as described in Venkataraman “The Chemistry of Synthetic Dyes” Vol. 6, pages 1-209, Academic Press, New York, London 1972 or EP-A-625 549 and U.S. Pat. No. 5,684,138 are suitable.

Further examples of reactive groups include reactive radicals containing carbo- or heterocyclic 4-, 5- or 6-rings substituted by a detachable atom or group. Examples of heterocyclic radicals include heterocyclic radicals which contain at least one detachable substituent attached to a heterocyclic ring; and those which contain at least one reactive substituent attached to a 5- or 6-membered heterocyclic ring, as to a triazine, pyridine or pyrimidine. The heterocyclic reactive radicals mentioned may further contain, via a direct bond or via a bridge member, further reactive radicals. Such reactive cyclodextrin derivatives are described in U.S. Pat. No. 5,728,823.

The present invention also includes compositions containing the hydrolyzate of the reactive cyclodextrin derivative. Hydrolyzates of reactive cyclodextrin derivatives are formed upon the reaction of the reactive groups with water in the known manner. Compositions containing reactive cyclodextrin derivatives are preferred.

Preferably the reactive group of the cyclodextrin derivative is vinylsulfonyl, α,β-dihalopropionyl, α-haloacryloyl, wherein halo is e.g. bromo or chloro, in particular bromo, or a nitrogen-containing heterocycle having at least one substituent selected from the group consisting of halogen, especially fluorine or chlorine, and unsubstituted or substituted pyridinium. It is to be understood that vinylsulfonyl will also include the precursors thereof, which correspond to the formula —SO₂—CH₂—CH₂-Z, wherein Z is a group removable under alkaline conditions. Z is for example —Cl, —Br, —F, —OSO₃H, —SSO₃H, —OCO—CH₃, —OPO₃H₂, —OCO—C₆H₅, —OSO₂—C₁-C₄alkyl or —OSO₂—N(C₁-C₄alkyl)₂. Z is preferably a group of formula —Cl, —OSO₃H, —SSO₃H, —OCO—CH₃, —OCO—C₆H₅ or —OPO₃H₂, especially —Cl or —OSO₃H and more especially —OSO₃H.

More preferably the reactive group of the cyclodextrin derivative is a nitrogen-containing heterocycle having at least one substituent selected from the group consisting of halogen, especially fluorine or chlorine, and unsubstituted or substituted pyridinium.

Specific examples of nitrogen-containing heterocyclic reactive groups are
a) a triazine group of formula 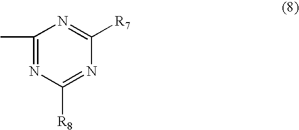
wherein
R₇ is fluorine, chlorine, unsubstituted or carboxy-substituted pyridinium or hydroxy, preferably fluorine, chlorine or unsubstituted or carboxy-substituted pyridinium, and
R₈ is as defined above for R₇ or is a radical of formula —OR₉ or —N(R₁₀)R₁₁, wherein
R₉ is hydrogen, alkali, C₁-C₈alkyl which is unsubstituted or substituted by hydroxy or C₁-C₄alkoxy, and
R₁₀ and R₁₁, independently from each other, are hydrogen; C₁-C₈alkyl which is unsubstituted or substituted by C₁-C₄alkoxy, hydroxy, sulfo, sulfato or carboxy; or phenyl which is unsubstituted or substituted by C₁-C₄alkyl, C₁-C₄alkoxy, halogen, nitro, carboxy or sulfo;
b) or a pyrimidinyl group of formula 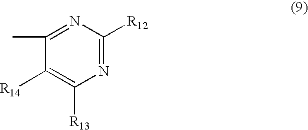
wherein
one of radicals R₁₂ and R₁₃ is fluorine or chlorine and the other one of radicals R₁₂ and R₁₃ is fluorine, chlorine, or is a radical of formula —OR₉ or —N(R₁₀)R₁₁ as defined above, and R₁₄ is C₁-C₄alkylsulfonyl, C₁-C₄alkoxysulfonyl, C₁-C₄alkoxycarbonyl, C₂-C₄alkanoyl, chlorine, nitro, cyano, carboxyl or hydroxyl;
c) or a dichloroquinoxaline group of formula

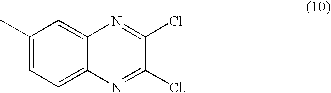

Highly preferred are groups of formula (6), especially those wherein R₇ is chlorine. R₈ is preferably a radical of formula —OR₉, wherein R₉ is hydrogen, alkali or C₁-C₈alkyl. Preferred radicals R₈ are those of formula —OR₉, wherein R₉ is hydrogen, alkali or C₁-C₄alkyl, especially hydrogen or alkali. Alkali is highly preferred. Alkali is preferably sodium.

The cyclodextrin derivatives contain e.g. 1 to 4, preferably 2 to 3 reactive groups. The cyclodextrin derivatives may be uncomplexed or complexed, for example, with antimicrobials, biocides, bactericides, insecticides, fungicides, pharmaceutical active compounds, UV-stabilizers, perfumes, fragrances, pheromones, vitamines or skin-, hair and textile benefit agents, e.g. UV-absorber, fatty acids, anti-irritants or inflammatory agents or cosmetic agents, e.g. skin firming, soothing, warming, cooling, wrinkle reducing or control agents.

The preparation of complexed reactive cyclodextrine derivatives can be carried out according to known processes, such as described in WO-A-02/22941.

The compositions may also comprise pH regulators, such as mineral acids, organic acids or bases.

As further additives, the aqueous liquid compositions according to the present invention may comprise textile-finishing agents, humectants, defoaming agents and antifreezing agents.

As textile finishing agents in the compostions according to the invention come into consideratation textile chemicals or compositions with the aim of adding a new or improving textile performance or consumer acceptability or desirability such as softening, raising, sanforizing, oil or water repellents, antifibrillation, flame retardant agents.

As humectants in the compositions according to the invention there come into consideration, for example, urea or a mixture of sodium lactate (advantageously in the form of a 50% to 60% aqueous solution) and glycerol and/or propylene glycol in amounts of preferably from 0.1 to 30% by weight, especially from 2 to 30% by weight.

The aqueous liquid composition can be prepared, for example, in the following manner. β-cyclodextrine, hydroxypropyl-β-cyclodextrine or one of the fiber reactive cyclodextrines (e.g. Cavasol W7 MCT®) is mixed with water and an emulsifier or a mixture of two or more emulsifiers, especially in a molar amount of cyclodextrine:emulsifier from 1:0.005 to 1:10.

Thereafter, water and a resin finishing or crosslinking agent is added, and if desired other textile finishing agents are added to the solution to obtain an aqueous liquid composition having the desired concentration of the cyclodextrin in textile finishing processes.

The amount of the resin finishing or crosslinking agent in the composition may vary between 1 and 300 gram per litre. The amount of cyclodextrine or cyclodextrine derivative may vary between 0.5 and 100 gram per litre.

The compositions according to the invention are suitable as benefit-agents in a finishing process for widely varying kinds of substrates, such as paper, textile fibre materials, keratineous fibres, e.g. human hair, leather, or films or foils of plastic made of polymers susceptible to the reaction with the fibre reactive cyclodextrin, for example, polyvinylalcohol or polymers or copolymers of acrylic acid, methacrylic acid or hydroxyethylmethacrylate, thereby modifying the surface of such substrates.

As resin finishing or crosslinking agent in a textile finishing process which may result in superior effect durability different agents can be used, for example, dimethylol-urea, dimethoxy-methyl-urea, trimethoxy-methyl-melamin, tetramethoxy-methyl-melamine, hexamethoxy-methyl-melamine, dimethylol-dihydroxy-ethylene-urea, dimethylol-propylene-urea, dimethylol-4-methoxy-5,5′-dimethyl-propylene-urea, dimethylol-5-hydroxypropylene-urea, butane-tetra-carboxylic-acid, citric acid, maleic acid, bonding agents, especially acrylates, silicones, urethanes and butadienes. Such textile finishing processes are described, for example, in DE-A-40 35 378.

A group of preferred resin finishing or crosslinking agents is selected from the group consisting of dimethylol-urea, dimethoxy-methyl-urea, trimethoxy-methyl-melamin, hexamethoxy-methyl-melamine, dimethylol-dihydroxy-ethylene-urea, dimethylol-propylene-urea, dimethylol-4-methoxy-5,5′-dimethyl-propylene-urea, dimethylol-5-hydroxypropylene-urea, butane-tetra-carboxylic-acid.

A very preferred resin finishing or crosslinking agent is dimethylol-dihydroxyethylene-urea.

The concentration of the resin finishing or crosslinking agent on the material, especially the textile fiber material is between 0.1 and 30% by weight of the weight of the material.

In order to achieve a two- or three-dimensional crosslinking and the connection of the cyclodextrine or its derivative with the material, especially the textile fiber material it is preferred to heat the material in an after treatment step up to 100 to 230° C. for 20 seconds to 10 minutes. Alternatively treatments of said material is also possible at ambient to elevated temperatures in the moist or wet material state; these are usually carried out under acidic conditions.

Preferred, as the substrates are textile fibre materials containing hydroxyl groups or containing nitrogen. Textile fibre materials can be in the form of fibre, yarn or piece goods, such as non-wovens, knitted and woven goods, pile fabrics or terry goods. Examples are silk, wool, polyamide fibres and polyurethanes, and in particular all types of cellulosic fibre materials. Such cellulosic fibre materials are, for example, the natural cellulosic fibres, such as cotton, linen and hemp, as well as cellulose and regenerated cellulose. The compositions according to the invention are also suitable for finishing fibres containing hydroxyl groups, which are contained in blend fabrics, for example mixtures of cotton with polyester fibres or polyamide fibres. The compositions according to the invention are particularly suitable for finishing cellulosic materials. They can furthermore be used for finishing natural or synthetic polyamide fibre materials.

The compositions according to the invention are applied to a finishing process which is a further subject of the present invention. The cyclodextrins are fixed, if appropriate after an alkali treatment, under the action of heat, steam or by storage at room temperature or slightly elevated temperature for several hours, thereby forming a durable cyclodextrine finish.

The finished substrates contain, for example, 0.05 to 25% by weight, preferably 0.1 to 10% by weight, and most preferably 0.5 to 3% by weight, of the cyclodextrine derivative, based on the total weight of the substrate.

The finished substrates can be used to complex within the cyclodextrin cavity, for example, UV-stabilizers, antimicrobials, biocides, bactericides, insecticides, fungicides, pharmaceutical active compounds, fragrances, perfumes, pheromones, vitamines or skin-, hair and textile benefit agents, e.g. UV-absorber, fatty acids, anti-irritants or inflammatory agents, or cosmetic agents, to e.g. solubilize water-insoluble or poorly water-soluble substances, to increase the bioavailability of active compounds; to stabilize substances against light, temperature, oxidation, hydrolysis or from volatility, to mask bad taste or unpleasant odor, to slowly release active compounds in a controlled manner over a prolonged period of time (delivery systems). On the other side, the finished substrates are useful to assimilate chemical substances, e.g. from a gaseous or liquid environment, which are captured in the cyclodextrin cavity, thereby serving as a collector system. Such collector systems may find application in the field of medical diagnostics or help to determine pollutants from the environment. Decomposition products of perspiration are trapped in the cyclodextrin cavity, thus diminishing or preventing malodor. Textile materials, such as clothings finished with the inventive composition stay fresh with a pleasant smell.

The inventive compositions are distinguished by good stability of the final finishing formulation for the textile treatment improving process reliability and finishing quality.

The following examples serve to illustrate the invention. Temperatures are stated in degrees Celsius, parts are parts by weight and the percentage data are based on percentages by weight, unless noted otherwise. Parts by weight bear the same relation to parts by volume as the kilogram to the litre.

### EXAMPLE 1

Cavasol® W7 HP TL (Hydroxypropyl-β-cyclodextrine available from Wacker Chemie AG, Germany) is neutralized. An aqueous composition is prepared by mixing the following components: 45 parts per litre of neutralized Cavasole W7 HP TL and 5 parts per litre of an aqueous solution containing 25% by weight of water, 25% by weight of the compound of the formula 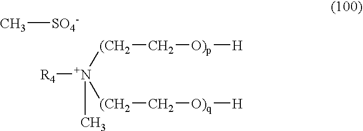
wherein R₄ is CH₃(CH₂)₁₇₋₂₁—, and the sum of p and q is 34,
and 50% by weight of the compound of the formula 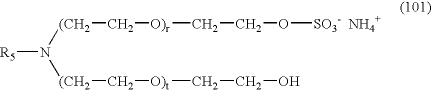
wherein R₅ is CH₃(CH₂)₁₅₋₁₈— and CH₃(CH₂)₇—CH═CH—(CH₂)₈— and the sum of r and t is 14, are mixed together with 40 parts per litre of CIBA Knittex® FEL, 12 parts per litre of magnesium chloride and 30 parts per litre of Ciba Ultraphil® HMS (textile finishing agent available from Ciba Specialty Chemicals) to give a stable composition without any flocculation.

### EXAMPLE 2

Cavasol® W7 HP TL (Hydroxypropyl-β-cydodextrine available from Wacker Chemie AG, Germany) is neutralized. An aqueous composition is prepared by mixing the following components: 47.5 parts per litre of neutralized Cavasol® W7 HP TL and 2.75 parts per litre of an aqueous solution containing 50% % by weight of water and 50% by weight of the isotridecyl alcohol of the formula 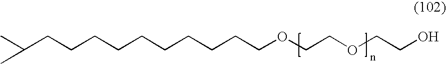
wherein n is 7 or 9, are mixed together with 40 parts per litre of CIBA Kniftex® FEL, 12 parts per litre of magnesium chloride and 30 parts per litre of Ciba Ultraphil® HMS (textile finishing agent available from Ciba Specialty Chemicals) to give a stable composition without any flocculation.

### APPLICATION EXAMPLE 1

1000 parts of the composition of Example 1 is used. The pH value is adjusted to 4.5 to 5. Single cotton Jersey is impregnated with the composition such that it increases by 80% of its weight, subsequently dried at romm·temperature (25° C.) and fixed for 40 seconds at 170° C.

The finished fabrics are submitted to a washing test at 60° C. (0 time, 5 times, 10 times and 20 times) under the following conditions:

Detergent: 30 g IEC 456-A (standard detergent)

Washing machine: Wascator FOM 71 MP LAB.

The presence of cycldextrine on the fabric was verfied by the decoloration of an alkaline phenolphtaleine solution. Ability of the finished fabric to reduce malodor has been tested by keeping 1 g specimens of the finished fabrics (unwashed, 5× washed, 10× washed and 20× washed) over night in closed bottles (content 100 ml) containing 50 mg of water and 20 mg of an ethanol solution (80 vol.-%) containing 0.1% p-cresol. The specimens were air-ventilated for 5 minutes. In any case a distinct reduction of malodor (p-cresol) was detected by 4 different test persons compared to unfinished specimens treated in the same manner.

### APPLICATION EXAMPLE 2

1000 parts of the composition of Example 2 is used. Different fabrics (knitted cotton, viscose and cotton/polyester (50/50) blends) are impregnated with the solution such that it increases by 70% of its weight, subsequently dried at room temperature (25° C.) and fixed for 1 minute at 160° C.

The finished fabrics are submitted to a washing test at 60° C. (0 time, 5 times, 10 times and 20 times) under the following conditions:

Detergent: 30 g IEC 456-A (standard detergent)

Washing machine: Wascator FOM 71MP LAB.

The presence of cycldextrine on the fabric was verfied by the decoloration of an alkaline phenolphtaleine solution. Ability of the finished fabric to reduce malodor has been tested by keeping 1 g specimens of the finished fabrics (unwashed, 5× washed, 10× washed and 20× washed) over night in closed bottles (content 100 ml) containing 50 mg of water and 20 mg of an ethanol solution (80 vol.-%) containing 0.1% p-cresol. The specimens were air-ventilated for 5 minutes. In any case a distinct reduction of malodor (p-cresol) was detected by 4 different test persons compared to unfinished specimens treated in the same manner.

1. An aqueous liquid composition comprising:
a) a cyclodextrin or a derivative thereof,
b) a resin finishing or crosslinking agent, and
c) at least one emulsifier of the formulae (1), (2), (3), (4), (5) or (6), 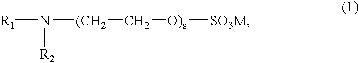
wherein R₁ and R₂ is alkyl or alkenyl having 12 to 24 carbon atoms, M is hydrogen, alkali metal or ammonium und s is an integer from 2 to 14, 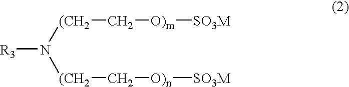
wherein R₃ is alkyl or alkenyl having 12 to 24 carbon atoms, M is hydrogen, alkali metal or ammonium and m und n are integers such that the sum of m and n is 2 to 14, 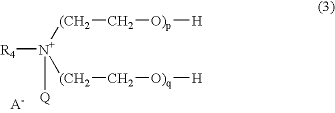
wherein R₄ is alkyl or alkenyl having 12 to 24 carbon atoms, Q is C₁-C₄ alkyl, A is an anion, and p und q are integers such that the sum of p and q is 15 to 55, 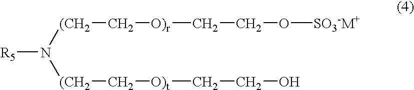
wherein R₅ is alkyl or alkenyl having 12 to 24 carbon atoms, r and t are integers such that the sum of r and t is 14 to 19 and M is an alklali metal or ammonium, 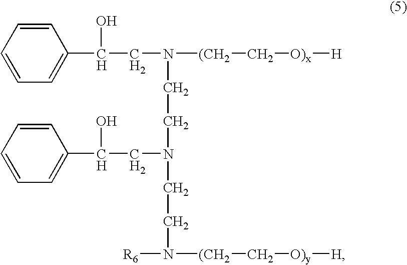
wherein R₆ is alkyl or alkenyl having 12 to 22 carbon atoms, x and y are integers such that the sum of x and y is 80 to 140, or
isotridecylalcohol containing 6 to 15 mols ethylene oxide of the formula 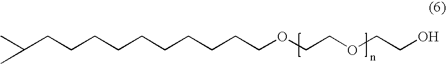
wherein n is an integer from 6 to 15.

2. An aqueous composition according to claim 1, wherein component a) is β-cyclodextrine or hydoxypropyl-β-cyclodextrine.

3. A composition according to claim 1, wherein component a) is a reactive cyclodextrin derivative or the hydrolyzate thereof.

4. A composition according to claim 1, wherein component a) is present in an amount of 0.05 to 70% by weight, based on the total weight of the composition.

5. A composition according to claim 1, wherein the molar ratio of cyclodextrin or cyclodextrin derivative and emulsifier is 1:0.005 to 1:10.

6. A composition according to claim 3, wherein the reactive group of the cyclodextrin derivative is a nitrogen-containing heterocycle having at least one substituent selected from the group consisting of halogen and unsubstituted or substituted pyridinium.

7. A composition according to claim 6, wherein the reactive group of the cyclodextrin derivative is
a) a triazine group of formula 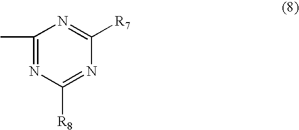
wherein
R₇ is fluorine, chlorine, unsubstituted or carboxy-substituted pyridinium or hydroxy, and
R₈ is as defined above for R₇ or is a radical of formula —OR₉ or —N(R₁₀)R₁₁, wherein
R₉ is hydrogen, alkali, C₁-C₈alkyl which is unsubstituted or substituted by hydroxy or C₁-C₄alkoxy, and
R₁₀ and R₁₁, independently from each other, are hydrogen; C₁-C₈alkyl which is unsubstituted or substituted by C₁-C₄alkoxy, hydroxy, sulfo, sulfato or carboxy; or phenyl which is unsubstituted or substituted by C₁-C₄alkyl, C₁-C₄alkoxy, halogen, nitro, carboxy or sulfo; or
b) a pyrimidinyl group of formula 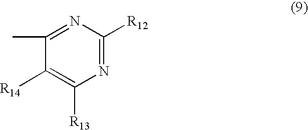
wherein one of radicals R₁₂ and R₁₃ is fluorine or chlorine and the other one of radicals R₁₂ and R₁₃ is fluorine, chlorine, or is a radical of formula —OR₉ or —N(R₁₀)R₁₁ as defined above, and
R₁₄ is C₁-C₄alkylsulfonyl, C₁-C₄alkoxysulfonyl, C₁-C₄alkoxycarbonyl, C₂-C₄alkanoyl, chlorine, nitro, cyano, carboxyl or hydroxyl; or
c) a dichloroquinoxaline group of formula

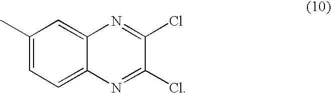

8. A composition according to claim 7, wherein the reactive group of the cyclodextrin derivative is a triazine group of formula (6), wherein
R₇ is chlorine, and
R₈ is a radical of formula —OR₉, wherein R₉ is hydrogen, alkali or C₁-C₈alkyl.

9. A composition according to claim 1, wherein the reactive cyclodextrin derivative contains 1 to 4 reactive groups.

10. A composition according to claim 1, wherein the resin finishing agent or the crosslinking agent is able to build a polymeric film on the textile fiber material or has the ability to react with nucleophlic or electophilc sites or chemical groups within the textile fiber material.

11. A composition according to claim 10, wherein the resin finshing or crosslinking agent is selected from the group consisting of dimethylol-urea, dimethoxy-methyl-urea, trimethoxy-methyl-melamine, tetramethoxy-methyl-melamine, hexamethoxy-methyl-melamine, dimethylol-dihydroxy-ethylene-urea, dimethylol-propylene-urea, dimethylol-4-methoxy-5,5′-dimethyl-propylene-urea, dimethylol-5-hydroxypropylene-urea, butane-tetra-carboxylic-acid, citric acid, maleic acid, and bonding agents selected from the group consisting of acrylates, silicones, urethanes and butadienes.

12. A composition according claim 1, wherein the composition further comprises a buffer selected from the group consisting of borax, borates, phosphates, polyphosphates, oxalates, acetates and citrates.

13. A finishing process comprising treating a substrate with the composition according to claim 1.

14. A finishing process according to claim 13, wherein the substrate is textile fiber material.
